(19) United States
(12) Patent Application Publication
(10) Pub. No.: US 2016/0077886 A1
(43) Pub. Date: Mar. 17, 2016

(54) GENERATING WORKLOAD WINDOWS

(71) Applicant: HEWLETT-PACKARD DEVELOPMENT COMPANY, L.P., Houston, TX (US)

(72) Inventor: Mykel John Kramer, Colorado Springs, CO (US)

(21) Appl. No.: 14/787,461

(22) PCT Filed: Jul. 31, 2013
(86) PCT No.: PCT/US2013/053024

§ 371 Date: Oct. 27, 2015

(51) Int. Cl. G06F 9/50; G06F 13/20

(52) U.S. Cl. CPC G06F 9/5083; G06F 13/20

(57) ABSTRACT

A method for generating workload windows includes incrementing access counters for each block of a storage system during execution of a workload accessing the storage system. The method also includes determining an average input-output (IO) rate of the storage system based on the access counters. The method further includes determining whether to generate a new workload window based on the average IO rate, an expiring timer, and a predetermined range from an X value to a Y value. The X value is equal to a low threshold of the average IO rate, and the Y value is equal to a high threshold of the average IO rate. The method also includes generating the new workload window based on the determination.

### BACKGROUND

In the context of a storage system, the term, workload, refers to application software and how much data the software accesses. Storage systems run many different types of workloads at any given time. In a balanced workload, the data accessed by the current workloads (in comparison to each other), may be balanced across the addressable hard drive space. In an imbalanced workload, the workloads may have orders of magnitude in difference.

### BRIEF DESCRIPTION OF THE DRAWINGS

Certain examples are described in the following detailed description and in reference to the drawings, in which:

FIG. 1 is a block diagram of an example system that may be used to regulate workload windows, in accordance with examples;

FIGS. 2A-2C are examples of input-output (IO) tables for regulating workload windows, in accordance with examples;

FIG. 3 is a process flow chart of an example method for regulating workload windows, in accordance with examples;

FIG. 4 is a block diagram of an example system that may be used to regulate workload windows, in accordance with examples; and

FIG. 5 is a block diagram showing an example tangible, non-transitory, machine-readable medium that stores code adapted to regulate workload windows, in accordance with examples.

### DETAILED DESCRIPTION

In a given storage system, the workload type may stay consistent over long periods of time. However, the workload type may also change completely over the course of hours, clays, or longer. Performance software that manages data resources for all workloads attempts to improve the efficiency of data accesses, also referred to herein as, input-outputs (IOs).

However, the performance software may be rendered less effective if the workload types are not consistent over time.

One approach to resolving this issue involves creating a timer that expires at regular time intervals. When the timer expires, an operation is performed on the existing, observed workload to normalize it in some way. Typically, the software also records snapshots of the workload balance at these intervals. Each snapshot represents a window of time (a workload window), with the normalizing software optimizing so that the workload balance shown in the most recent workload window has greater influence than older windows.

However, the expiring timer approach is not as effective when a workload is not consistent, in terms of total work. For example, two workloads may be equally distributed across the addressable space, but one workload may merely perform half the IOs of the other. That means the smaller workload can be more reactive to changes in the workload, because it has less data saved from its previous window. Reactive may describe how effectively workloads are normalized by the performance software. So, if each workload window records data from a previous window to determine how to plan for the next workload window, previous windows have less influence because there is less data. The increase in data volume may dilute the lower data volumes workload windows from the past. However, for the larger workload, there may be no increase in the volume of data; as such, the larger load is less reactive. Influenced more strongly by previous windows, in comparison to the smaller workload.

Aside from not being consistently reactive for all workloads, it may be a challenge to specify one time for the timer that maintains consistency of workload types over time. As the specified timer may provide a certain amount of reactivity and sensitivity, as workload sizes change, the workloads may become not reactive at all, or too reactive, even with without changes to the expiring timer value.

In contrast, examples of the present techniques allow for a windowed view of a workload that is consistently reactive: across workloads in a current window, and across successive workload windows. In one example, each workload window is thus more likely to be similar to the last window in comparison to successive windows in other methods. Additionally, presenting a workload that maintains certain consistencies enables the underlying algorithms to perform more efficiently because of the consistent condition of successive workloads.

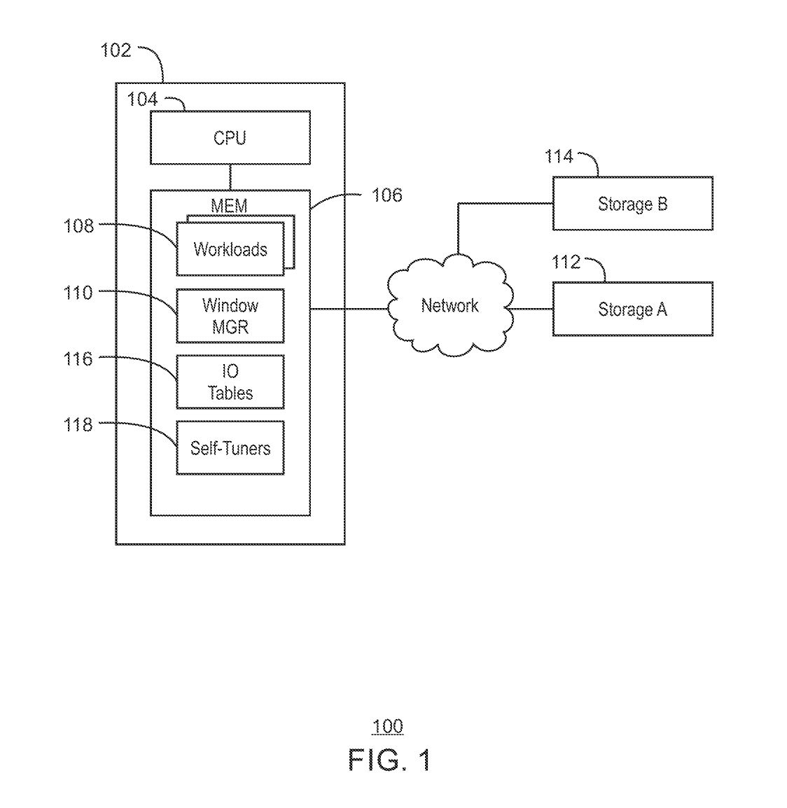

FIG. 1 is a block diagram of an example system 100 that may be used to regulate window workloads, in accordance with embodiments. The system 100 includes a computational unit 102 in communication with at least two forms of addressable disk storage over a network 120. Storage A 112 represents fast-access storage, which means that a CPU 104 can access a block from storage A 112 faster than the CPU can access a block from storage B 114. In one example, the storage A 112 and the storage B 114 represent tiers of an auto-tiering system.

The computational unit 102 includes the CPU 104 and a memory 106. The memory 106 includes workloads 108, a window manager 110, IO tables 116, and self-tuners 118. The workloads 108 represent the jobs running on the CPU 104. The window manager 110 generates windows that are used to tune performance of access to storage A 112. The windows are represented, in part, by IO tables 116. The IO tables 116 include the number of accesses to each block of storage A 112 and storage B 114.

The memory 106 also includes self-tuners 118. The self-tuners 118 may swap memory between storage A 114 and storage B 116. Specifically, the self-tuners 118 make decisions about whether to swap a specific block of storage B 114 with a block of storage A 116 based on the average number of accesses being performed by the current workload. In an example, a range of access values is also used to make this determination.

Workload windows are generated based on the expiring timer and by an X-Y range, where X represents a low end of the range, and Y the high end. The X-Y range represents a range of average counts of accesses to the storage A 112. Thus, if the average count is above V before the expiring timer triggers, the next workload window is generated, and the timer reset. A workload window is also generated if the timer fires and the average is within the X-Y range. However, if the timer fires and the average is below X, no workload window is generated. Rather, the workload windows are not generated unless the average count meets or exceeds X. The X and Y values are also used by the self-tuners 118 to set the remaining values used for swapping blocks, and for tiering in auto-tiering systems. These conditions for generating new workload windows are summarized in Table 1:

TABLE 1

| Average Access Count | Timer Expired | Timer Not Expired |
|---|---|---|
| Less than X | Do not generate new | Do not generate new |
| | workload window | workload window |
| Within (X, Y) Range | Generate new workload | Nothing happens |
| | window | |
| Greater than Y | Generate new workload | Generate new |
| | window | workload window |

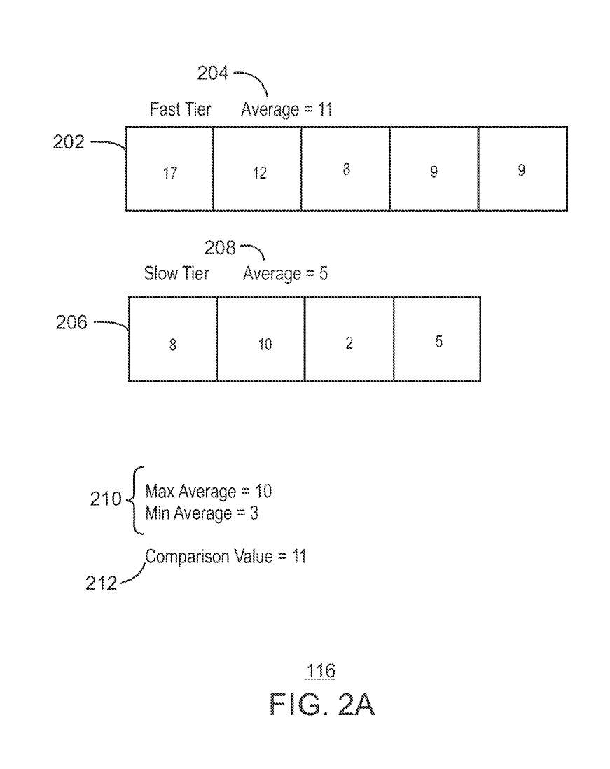

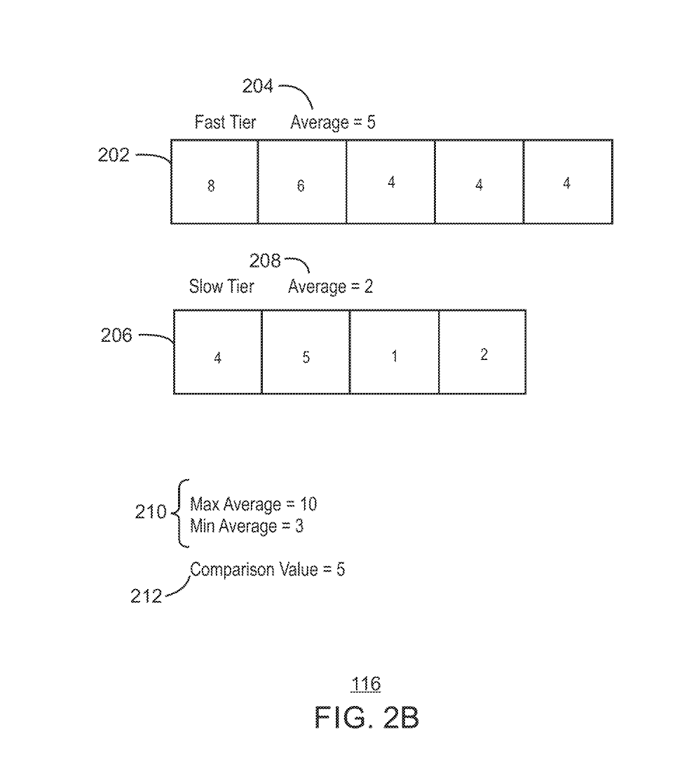

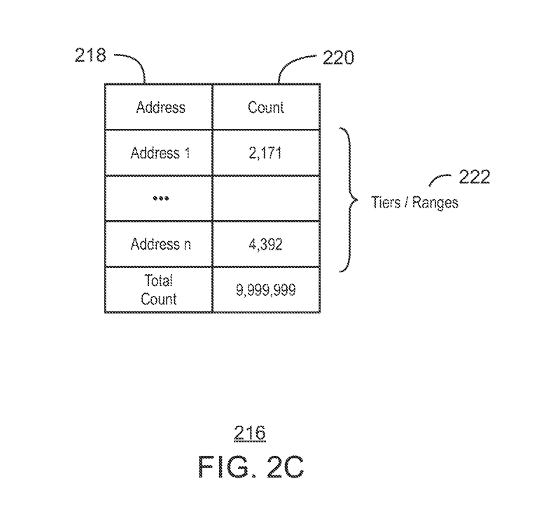

FIGS. 2A-2C are examples of input-output (IO) tables 118 for regulating workload windows, in accordance with examples. These examples represent a storage system 100, such as an auto-tiering system, where the specified X-Y range 210 is between 3 IOs per block and 10 IOs per block. Swaps are determined based on a comparison value 212, which is determined by the self-tuners.

In FIG. 2A, the system 100 has been running for a while, the IO tables 116 have accumulated these counts for blocks in the fast tier 202, with an average IO rate 204 of 11, and the slow tier 206, with an average IO rate 208 of 5. In the fast tier 202, the average IO rate on the fast tier is 11, which is above the specified Y. The system is tuned to work on average IO rates between 3 and 10, so a new workload window is generated.

In one example, when the new workload window is generated, the counts 202, 206 are all zeroed. In another example, every count 202, 206 is divided by a specified factor, which may be rounded down. In such an example, the history of the counts influences future decisions about swaps, so their influence is decayed rather than cleared, as in the zeroing example.

In FIG. 2B, the new window is created, including counts that have been reduced by a factor of two. In this example, the counts 202, 206 are in the specified X-Y range 210 again. If the IO rate brings the average count below the specified X value, i.e., 3, then no new workload windows are generated until the average count is equal to or greater than X. The system 100 continues operating in this manner, keeping the counts 202, 206 within the specified X-Y range.

in FIG. 2C, an example IO table 216 is shown. The IO table 216 includes an address 218 of addressable disk space and a count 220 for the current window. In an example, multiple blocks of address space may be specified, such as tiers or ranges of blocks 222. As shown, the total number of lOs is also maintained. Accordingly, an average access rate can be determined by dividing the total accesses by the number of addresses 218, for example, in the IO table 216.

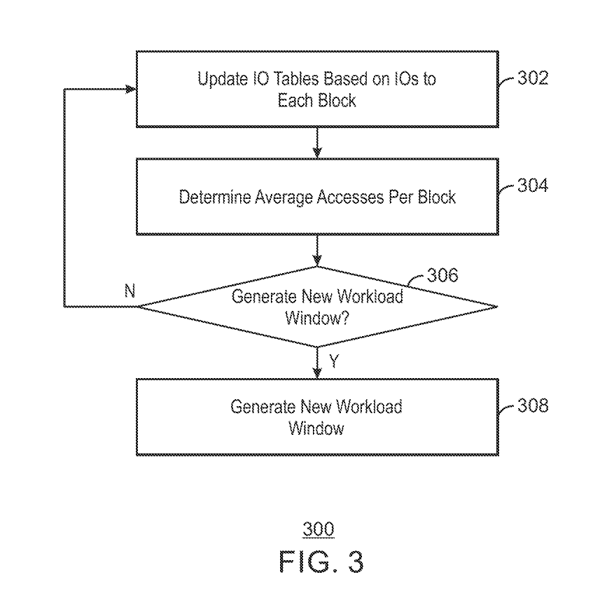

FIG. 3 is a process flow chart of an example method 300 to regulate window workloads, in accordance with examples. The method 300 begins at block 302, where the IO tables 116 are updated based on lOs to each address block. As stated previously, the access counts may be tracked for individual addresses, or ranges of addresses. Each time one of the workloads 108 accesses addressable disk space, the entry in the IO tables 116 for the appropriate address, or block, is incremented.

Additionally, the total count across all entries is also tracked. This total can represent the total of all entries across the workloads' possible addressable disk space targets. Alternatively, in the case of a tiered storage system, the tiers may each have their own total. In such a scenario, it is possible that the highest tier total may be used to make decisions in an auto-tiering system.

At block 304, an average is determined. To keep the math consistent across different size platforms, an average count is made accessible to the self-tuners. This average is represented by the total count divided by the total entries storing these counts.

At block 306, the window manager 110 determines whether to generate a new workload window. The determination is based on the expiring timer, the average accesses, and the X-Y range. If the expiring timer has expired, and the average access is less than X, control flows back to block 302. However, if the expiring timer has not expired, and the average count is less than Y, control flows back to block 302.

Further, regardless of whether the expiring timer has expired, if the average count is above Y IOs per block, then a new workload window is generated at block 308. Similarly, if the average count is equal to or greater than X, and the expiring timer has expired, a new workload window is generated at block 308.

Generating a new workload window may mean different things for different implementations. In sonic cases, all access counts may be set to zero. In others, like auto-tiering, the counts may be divided by a factor to reduce or lessen the influence of values from older windows.

This enables the self-tuners 118 described with respect to FIGS. 1 and 2A-E to be configured based on the values of X and Y being static. In the case of an auto-tiering application, sorting decisions may be based on the last 4,000 IOs per block (or any other specified threshold). Advantageously, because the determinations are based on the average count, which changes in values between (X, Y), the self-tuners 118 can be configured to allow for a small range of IO frequency, i.e., reactiveness. The software can stay at a desired reactiveness regardless of how much the workload is changing above the window presented to the self-tuner 118. In one example, this windowed approach may reduce the potential of erratic behavior from changing user workload in comparison to the expiring timer approach.

Auto-tiering makes comparisons on the block counts that are slowly accumulating. In one system, having 500 more IOs than another block in an hour may be a big difference. In another system, 400 IOs may be a large difference within an hour time period. Maintaining the average count enables comparisons, such as done by the self-tuners 118, to adapt differences in access rates that would be useful in determining a threshold access rate for performing swaps, such as described with respect to FIGS. 2A-2E.

In contrast, using an expiring timer, with a specified hard count does not allow for rapid changes that can go unaccounted for if they occur before the tinier expires. However, the self-tuners 118 automatically enable two customers with orders of magnitude difference in workload, over the same addressable space, to perform equally, in terms of their reactivity.

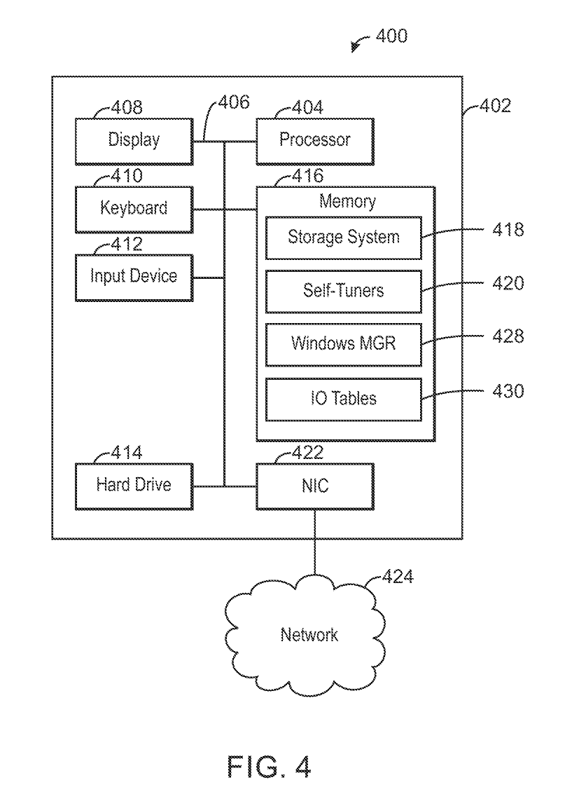

FIG. 4 is a block diagram of an example system 400 that may be used to regulate window workloads, in accordance with embodiments. The functional blocks and devices shown in FIG. 4 may include hardware elements including circuitry, software elements including computer code stored on a tangible, non-transitory, machine-readable medium, or a combination of both hardware and software elements. Additionally, the functional blocks and devices of the system 400 are but one example of functional blocks and devices that may be implemented in examples. The system 400 can include any number of computing devices, such as cell phones, personal digital assistants (PDAs), computers, servers, laptop computers, or other computing devices.

The example system 400 can include a computer 402 having a processor 404 connected through a bus 406 to a display 408, a keyboard 410, and an input device 412, such as a mouse, touch screen, and so on. The computer 402 may also include tangible, computer-readable media for the storage of operating software and data, such as a hard drive 414 or memory 416. The hard drive 414 may include an array of hard drives, an optical drive, an array of optical drives, a flash drive, and the like. The memory 416 may be used for the storage of programs, data, and operating software, and may include, for example, the BIOS (not shown).

The memory 416 also includes a storage system 418, self-tuners 420, a windows manager 428, and IO tables 430. Examples of the claimed subject matter may break down workloads on a storage system 418 into smaller, consistent windows generated by the windows manager 428. Advantageously, this approach enables the self-tuners 420 to deal with a smaller subset of possible workload access ranges, rather than trying to handle every possible combination of workload access rates the storage system 418 could experience, as in current methods. Additionally, this method also makes it easier for auto-tiering systems to maintain reactivity regardless of how: fast or slow; even or unbalanced; narrow or wide, the workloads are.

The computer 402 can be connected through the bus 406 to a network interface card (MC) 422. The MC 422 can connect the computer 402 to a network 424. The network 424 may be a local area network (LAN), a wide area network (WAN), or another network configuration. The network 424 may include routers, switches, modems, or any other kind of interface devices used for interconnection. Further, the network 424 may include the Internet or a corporate network. The computer 402 may communicate over the network 424 with one or more remote computers 426. The remote computers 426 may be configured similarly to the computer 402. In one example, the computers 426 may represent additional storage systems, such as the storage system 418.

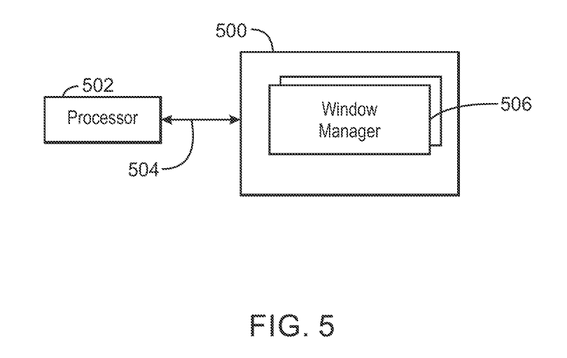

FIG. 5 is a block diagram showing an example tangible, non-transitory, machine-readable medium 500 that stores computer-implemented instructions adapted to generate workload windows. The machine-readable medium is generally referred to by the reference number 500. The machine-readable medium 500 may correspond to any typical storage device that stores computer-implemented instructions, such as programming code or the like. Moreover, the machine-readable medium 500 may be included in the storage 416 shown in FIG. 4. When read and executed by a processor 502, the instructions stored on the machine-readable medium 500 are adapted to cause the processor 502 to process the instruction of a windows manager 506. The windows manager 506 may break down a workload on a system into smaller, consistent windows. This approach enables the self-tuners 420 to deal with a smaller subset of possible workload inputs, rather than trying to handle every possible combination of access rates and load sizes the system 418 could experience. Additionally, auto-tiering is enabled to maintain reactivity to workloads, regardless of how: fast or slow; even or unbalanced; narrow or wide, the workloads are.

What is claimed is:

1. A method for generating workload windows, the method comprising:
incrementing access counters for each block of a storage system during execution of a workload accessing the storage system;
determining an average input-output (IO) rate of the storage system based on the access counters;
determining whether to generate a new workload window based on the average IO rate, an expiring timer, and a predetermined range from an X value to a Y value, the X value being equal to a low threshold of the average IO rate, the Y value being equal to a high threshold of the average IO rate; and
generating the new workload window based on the determination.

2. The method of claim 1, the new workload window being generated if the average IO rate is equal to or greater than the high threshold of the average IO rate.

3. The method of claim 1, the new workload window being generated if the expiring timer expires and the average IO rate is equal to or greater than the low threshold of the average IO rate.

4. The method of claim 1, the new workload window not being generated if the average IO rate is less than the low threshold of the average IO rate.

5. The method of claim 1, wherein generating the new workload window comprises dividing the access counters by a predetermined factor.

6. The method of claim 5, the divided access counters being rounded.

7. The method of claim 1, the storage system being an auto-tiering system.

8. The method of claim 1, wherein generating the new workload window comprises zeroing the access counters.

9. The method of claim 1, the block being a predetermined range of addressable disk space of the storage system.

10. The method of claim 1, the block being a predetermined address of addressable disk space of the storage system.

11. A storage system, comprising:
a processor that is adapted to execute stored instructions; and
a memory device that stores instructions, the memory device comprising:
computer-implemented instructions to increment access counters for each block of a storage system during execution of a workload accessing the storage system;
computer-implemented instructions to determine an average input-output (IO) rate of the storage system based on the access counters;
computer-implemented instructions to determine whether to generate a new workload window based on the average IO rate, an expiring timer, and a predetermined range from an X value to a Y value, the X value being equal to a low threshold of the average IO rate, the Y value being equal to a high threshold of the average IO rate;
computer-implemented instructions to generate the new workload window based on the determination;
computer-implemented instructions to generate the new workload window if the average IO rate is equal to or greater than the high threshold of the average IO rate;
computer-implemented instructions to generate the new workload window if the expiring timer expires and the average IO rate is equal to or greater than the low threshold of the average IO rate; and
computer-implemented instructions to not generate the new workload window if the average IO rate is less than the low threshold of the average IO rate.

12. The storage system of claim 11, wherein generating the new workload window comprises dividing the access counters by a predetermined factor.

13. The storage system of claim 12, the divided access counters being rounded.

14. The storage system of claim 11, the storage system being an auto-tiering system.

15. A tangible, non-transitory, machine-readable medium that stores machine-readable instructions executable by a processor to generate workload windows, the tangible, non-transitory, machine-readable medium comprising:
machine-readable instructions that, when executed by the processor, increments access counters for each block of a storage system during execution of a workload accessing the storage system, the storage system being an auto-tiering system;
machine-readable instructions that, when executed by the processor, determines an average input-output (IO) rate of the storage system based on the access counters;
machine-readable instructions that, when executed by the processor, determines whether to generate a new workload window based on the average IO rate, an expiring timer, and a predetermined range from an X value to a Y value, the X value being equal to a low threshold of the average IO rate, the Y value being equal to a high threshold of the average IO rate;
machine-readable instructions that, when executed by the processor, generates the new workload window based on the determination;
machine-readable instructions that, when executed by the processor, generates the new workload window if the average IO rate is equal to or greater than the high threshold of the average IO rate;
machine-readable instructions that, when executed by the processor, generates the new workload window if the expiring timer expires and the average IO rate is equal to or greater than the low threshold of the average IO rate; and
machine-readable instructions that, when executed by the processor, does not generate the new workload window if the average IO rate is less than the low threshold of the average IO rate, wherein generating the new workload window comprises dividing the access counters by a predetermined factor, the divided access counters being rounded.
